(19) United States
(12) Patent Application Publication
(10) Pub. No.: US 2014/0091650 A1
(43) Pub. Date: Apr. 3, 2014

(54) POLE SHOE

(71) Applicant: Gerhard Lenschow, Aurich (DE)

(72) Inventor: Gerhard Lenschow, Aurich (DE)

(73) Assignee: WOBBEN PROPERTIES GMBH, Aurich (DE)

(21) Appl. No.: 14/007,936

(22) PCT Filed: Mar. 26, 2012
(86) PCT No.: PCT/EP2012/055350

§ 371 Date: Dec. 3, 2013

(30) Foreign Application Priority Data
Apr. 1, 2011 (DE) 102011006681.0

(51) Int. Cl. H02K 9/00

(52) U.S. Cl. CPC H02K 9/005
USPC 310/54

(57) ABSTRACT

The invention relates to a pole shoe of an electrical machine, in particular a rotor of an electrical generator of a wind turbine generator system, comprising a pole shoe body for conducting a magnetic field and for receiving a winding for conducting an electrical current, in particular an excitation current, for producing the magnetic field, and at least one heat sink, entirely or partially surrounding the pole shoe body, for cooling the pole shoe, wherein the heat sink is arranged between the pole shoe body and the winding.

### BACKGROUND

1. Technical Field

The present invention relates to a pole shoe of an electrical machine, in particular a rotor of an electrical generator of a wind turbine generator system. The present invention relates further to a generator, in particular to a ring generator, as well as to a pole shoe heat sink and a wind turbine generator system. Furthermore, the present invention relates to a method for manufacturing a pole shoe as well as to a method for operating a wind turbine generator system.

2. Description of the Related Art

A pole shoe generally serves the purpose of leading a magnetic field and of letting the magnetic field lines exit in a defined form and distributing them. Such a pole shoe consists of a material with a high permeability. In electrical machines, for example in an electrical generator of a wind turbine generator system, pole shoes are located in the stator and/or rotor of the generator. In the following, pole shoe will mean a laminated pole shoe core, which, to prevent or to at least reduce eddy currents, is constructed of a number of different sheet metal lamellas, isolated from each other. Essentially, such a pole shoe includes a pole shoe head and a pole shoe body.

In particular, for slowly rotating generators, such as the ones of a gearless wind turbine generator system, a high excitation current is required, i.e., the current that flows through an excitation winding and thus creates a magnetic field. This leads to an increase of the excitation power loss. One option for increasing the output of such a generator is to increase the excitation current. In order to dissipate the lost energy, which is increasing through this, cooling systems for cooling the generator are used.

From the document DE 10 124 268 A1, for example, a generator cooling system is known. The document relates to a wind power system with a ring generator and a gondola housing of the wind power system enclosing the ring generator, wherein, in the area of the ring generator, the gondola housing has a heat conducting housing section and a defined distance between the outer periphery of the ring generator and the heat conducting housing section exists so that the heat energy can be conducted through or respectively by the air.

In general, air cooling, water cooling or combined air-water cooling systems are known for generators. Some of these above mentioned solutions have a very low cooling performance or are time and cost extensive, since they require changes to the design of the generator.

Regarding further prior art, at this point, general reference is made to the following prior art documents: CH 425 984 A, U.S. Pat. No. 6,774,504 B1 as well as EP 0 793 870 B1.

### BRIEF SUMMARY

One or more embodiments of the present invention are directed to solving, or at least to reducing, at least one of the above described problems. In particular, an improved cooling of a pole shoe of an electrical machine, in particular of a rotor of an electrical generator of a wind turbine generator system is to be made possible. At least one alternative solution shall be proposed.

One embodiment includes a pole shoe of an electrical machine, in particular of a rotor of an electrical generator of a wind turbine generator system, comprising a pole shoe body for conducting a magnetic field and for receiving a winding for conducting an electrical current, in particular an excitation current, for producing the magnetic field. The pole shoe body is entirely or partially surrounded by at least one heat sink, which can also be referred to as pole shoe heat sink, for cooling the pole shoe. The heat sink is arranged between the pole shoe body and the winding. The winding can be a part of the pole shoe.

Preferably, the heat sink is designed in such a way that it receives the winding and thus forms a cooled, in particular a water-cooled, spool body.

The pole shoe body may, for example, have a laminated design and be made of iron. Thus, within the pole shoe, eddy currents can be prevented, or at least reduced. Preferably, the pole shoe body is designed in the form of a cuboid, where the corners are left open forming recesses. Through these recesses, winding material is saved. In the case of the winding of a pole shoe of a rotor of a generator of a wind turbine generator system, for example, in particular if the winding is made of copper, up to or even more than 2 kg or more than 3 kg of material can be saved per pole shoe.

If such a pole shoe is, for example, mounted in a rotor of a generator of a wind turbine generator system, through the arrangement of a cooling system, the excitation current that is fed into the winding, and, thus, the output of the generator, can be increased. The fact that the heat sink is located between the pole shoe body and the winding leads to a close thermal contact between the heat sink and the heat source, i.e., the winding, and the heat source is cooled directly. Thus, the heat is dissipated before the pole shoe gets too warm so that damage due to overheating of the winding is prevented. Heat arising in the pole show body, e.g., through the loss of eddy currents and loss of iron, can also flow from the pole shoe body to the heat sink and be conducted in a simple manner.

In a preferred embodiment of the pole shoe according to the invention, the heat sink is designed as a winding body, wherein the winding body is preferably adapted to the pole shoe body and slid onto it. The winding is arranged on the winding body. Thus, the heat sink is located between the pole shoe body and the winding, and the heat of the heat source can be directly conducted. Alternatively, a winding body and a heat sink could be arranged between the winding and the pole shoe body.

Preferably, the pole shoe comprises an electrical insulating means to electrically insulate the heat sinks against the winding and/or to conduct heat from the winding to the heat sink. The insulating means can, for example, comprise an insulation foil, mica discs or small ceramic plates. For insulation, electrically insulating layers made of oxides, such as aluminum oxide, also known as passivation layer, can be considered as well. Furthermore, layers in the form of paint can also be considered for insulation, e.g., similar to the insulating paint of a copper wire.

In a preferred embodiment of the pole shoe according to the invention, the heat sink is of a hollow design in order to convey a coolant. As coolant, in particular a cooling fluid is used. Such a cooling fluid can, for example, comprise water. This has the advantage that a consistent heat transport is ensured and a large amount of heat is conducted. Preferably, such a cooling fluid will contain an anti-freezing agent, such as glycol. Thus, it is ensured that the cooling fluid does not freeze even in the case of downtime of the electrical machine.

Alternatively, the coolant may also be gaseous, or comprise, at least partially, solid materials or material compounds, or, for example, consist of gel.

According to an embodiment, it is proposed that the heat sink is made of aluminum. Aluminum has the advantage that it is a metal with good thermal conductivity and, thus, is able to conduct the lost heat through thermal conduction away from the heat generating element, i.e., the winding. Alternatively, the heat sink could also be made of copper, which is also a metal with good thermal conductivity.

Preferably, the heat sink has at least two connections for the connection to a cooling system so that, together with the heat sink, the cooling system can form a cooling circuit. Through one of the connections, a or respectively the coolant is conducted into the heat sink, and through one of the other connections, the coolant is conducted out of it. Thus, when it flows into the heat sink, the coolant has an initial temperature that is below the temperature of the heat source, and a heat transfer from the warmer to the cooler medium, i.e., the coolant, takes place. After this, the warmed up coolant is conveyed out of the heat sink, and once cooled, fed into the cooling circuit again. The cooling is performed, for example, by means of a heat exchanger, that gives off the heat to be conducted to the surroundings. In the case of a wind turbine generator system, such a heat exchanger is, for example, arranged at the nacelle of the wind turbine generator system.

If, as already described above, the pole shoe body is provided with recesses at its corners, the connections of the heat sink can be arranged in these recesses, or respectively in two of these recesses, and thus make efficient use of the space.

According to an embodiment of the invention, the pole shoe is prepared for use in a salient pole machine, in particular in a ring generator. Such a salient pole machine is a three-phase synchronous machine designed for slower rotational speeds, which is, for example, used as a generator in wind turbine generator systems. A ring generator is characterized by a high number of rotor and stator poles, which are arranged in the form of a ring along the air gap. Due to the high number of poles—for example 30, 40, or, in particular, 48, 50 and more rotor poles can be provided—operation at a very slow rotational speed, where the generator turns with less than 30, 20, 15 and, in particular, less than 10 revolutions per minute, is enabled.

Preferably, one or more embodiments of the invention comprise a generator, in particular a ring generator, for transforming kinetic energy into electrical energy by means of a stator and a rotor, wherein the stator and/or the rotor comprises at least two pole shoes according to the invention. In such a ring generator, for example in a wind turbine generator system, the excitation of the magnetic field takes place via the pole shoes mounted to the rotor. If these pole shoes are directly cooled, the output of the wind turbine generator system can be increased or respectively an increase can be made possible through the conduction of a power loss generated by a high excitation current. On the other hand, the service life of the wind turbine generator system can be increased through a good cooling system and, thus, through the prevention of too high temperatures. Through the use of a fluid-based cooling system instead of an ambient air cooling system, stress caused by the ambient air can be prevented. Humidity and dirt can be kept out of the system.

Preferably, the at least two pole shoes at the rotor or the stator respectively comprise a winding arranged around the respective heat sink in such a way that the heat sink is arranged between the pole shoe body and the winding. Thus, direct cooling of the heat source is possible.

Furthermore, according to one embodiment of the invention, a pole shoe heat sink for cooling a pole shoe and for being used together with a pole shoe according to the invention is proposed. Such a pole shoe heat sink is designed as a rigid body and adapted to a pole shoe, in particular to the pole shoe body of a pole shoe. Thus, the pole shoe body can be used for different embodiments of the pole shoe, such as different sizes and shapes. The pole shoe itself is subject to no or merely minor modifications to its design. After the installation of the heat sink and the insulation foil, the pole shoe body can be equipped with the winding and be integrated into the electrical machine. Only the connections of the cooling circuit and the pertaining cooling system result in a deviating design as compared to generators without or with another cooling system.

According to an embodiment, it is proposed that the pole shoe heat sink, which, in the following will be simply referred to as heat sink, comprises or respectively forms a receiving space for receiving a pole shoe body. In this context, a receiving space is a space defined by the shape of the heat sink, which is designed to receive at least a part of the pole shoe body, which is to be surrounded by the pole shoe heat sink. Thus, the heat sink, which preferably is designed as a rigid body, can, for example, be slid onto the pole shoe body without great efforts.

Furthermore, according to one embodiment of the invention, a wind turbine generator system with a generator according to the invention is proposed, wherein the required thermal output can be conducted by a cooling system and, thus, the output be increased.

In addition, according to one embodiment of the invention, a method for manufacturing a pole shoe according to the invention is proposed. Preferably, such a method comprises the following steps:

1. First of all, one (or the) heat sink is arranged on one (or the) pole shoe body for cooling the pole shoe. This can be performed, for example by sliding it onto the pole shoe body.

2. Subsequently, one (or the) winding is arranged on the heat sink. The heat sink is arranged on the pole shoe body in such a way that it entirely or partially surrounds the pole shoe body and that it is arranged between the winding and the pole shoe body. Thus, the general method for manufacturing a pole shoe is merely complemented by the arrangement of the heat sink.

Alternatively, it is suggested that the winding be arranged on the heat sink and that the heat sink then be slid onto the pole shoe body together with the winding already arranged on it.

Furthermore, a method for operating a wind turbine generator system according to the invention is proposed. The generator is cooled by means of a coolant, in particular of a cooling fluid, which is pumped through at least one pole shoe heat sink. In the operation of a wind turbine generator system, the coolant for cooling the generator is preferably conveyed to a heat exchanger through one (or the) connection. This heat exchanger is located in or on the nacelle of the wind turbine generator system, preferably on at least one outer face of the nacelle. Such a heat exchanger is, for example, subject to an air flow and has a sufficiently large surface to ensure a required heat release. Thus, the coolant can be cooled in the heat exchanger and be pumped back into the pole shoe heat sink through one (or the) wider connection to continue dissipate the lost heat of the pole shoe.

### BRIEF DESCRIPTION OF THE SEVERAL VIEWS OF THE DRAWINGS

By way of example, the invention is described in more detail below by means of some exemplary embodiments, with reference to the accompanying figures.

FIG. 1A shows an isometric view of a winding body with a pole shoe heat sink according to one embodiment of the invention.

FIG. 1B is a cross section view of FIG. 1A and further illustrating windings.

FIG. 2 shows an exemplary embodiment of a pole shoe heat sink.

FIG. 3 shows another exemplary embodiment of a pole shoe heat sink.

FIG. 4 shows a connection area of a pole shoe heat sink according to another embodiment.

FIG. 5 shows a pole shoe heat sink with a pole shoe body of a pole shoe according to another embodiment.

FIG. 6 shows an embodiment of a pole shoe according to the invention

FIG. 7 shows a section of a pole shoe according to another embodiment.

### DETAILED DESCRIPTION

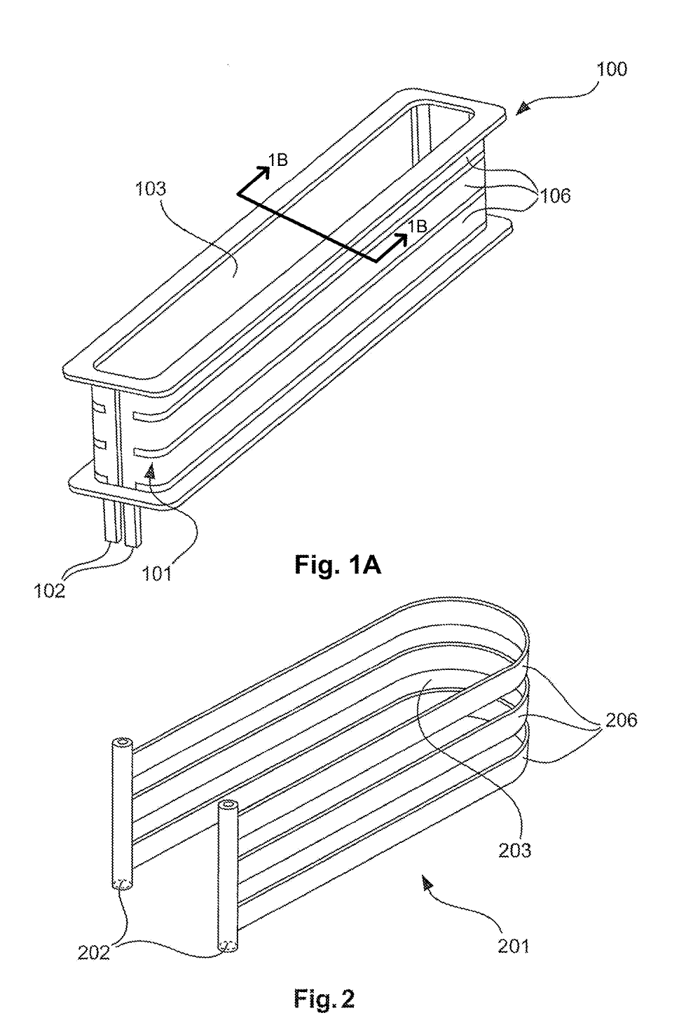

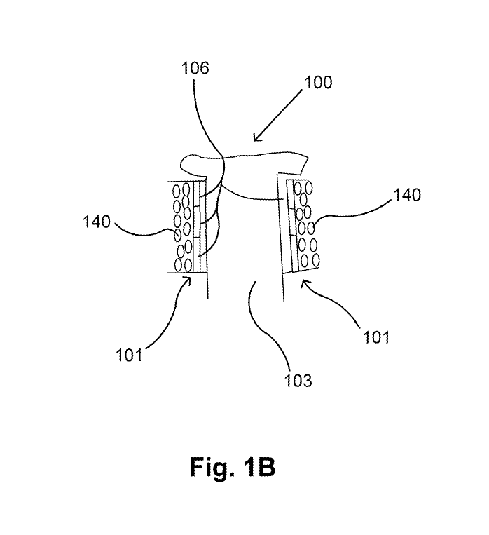

FIGS. 1A and 1B show a winding body 100 for a pole shoe with a heat sink in the form of a pole shoe heat sink 101, two connections 102 and a receiving space 103, wherein the pole shoe heat sink 101, which includes three sub-bodies 106 connected with each other via the connections 102, is already arranged on the winding body 100. A receiving space 103 is provided to receive a pole shoe body. The heat sink 101 entirely surrounds the receiving space 103 and thus, after the pole shoe body has been inserted, also the pole shoe body so that consistent cooling is ensured.

In order to pump a coolant, preferably water, into the heat sink 101 and to convey it out again, the heat sink 101 has two connections 102. Through one of the connections 102, the coolant is, for example, conveyed to a heat exchanger, where it is cooled. Through the second connection 102, the coolant is pumped back into the heat sink 101. The illustrated winding body 100 is slid onto the pole shoe body of a pole shoe. An insulating means, which is not shown in the figure and on which, in turn, a winding 140 (FIG. 1B) is arranged, is installed on the heat sink 101. The pole shoe, which has been prepared as described above, can be installed in the respective location in the electrical machine.

FIG. 2 shows a rigid heat sink 201 comprising three sub-bodies 206, which are also rigid. The heat sink 201 defines a receiving space 203 for receiving a pole shoe body. The three sub-bodies respectively form a rigid, circumferential and hollow, tape-like element, through which the water as a cooling fluid can be conveyed. When the pole shoe body is inserted into the receiving space 203 the heat sink 201 surrounds it almost entirely so that consistent cooling is ensured.

In addition, two connections 202 are shown in FIG. 2. Through these, the coolant can be conveyed into or respectively out of the heat sink 201.

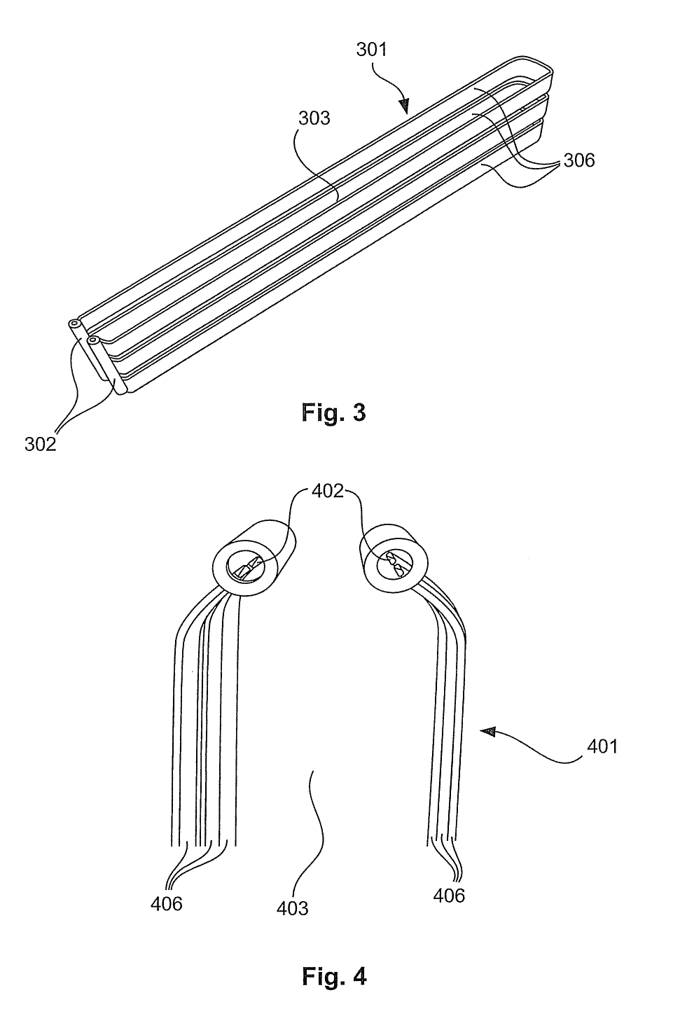

FIG. 3 shows another embodiment of a heat sink 301 with three sub-bodies 306. This heat sink, too, comprises a receiving space 303 for receiving a pole shoe body as well as two connections 302 for conveying a coolant in or out of the heat sink. The heat sinks 201 in accordance with FIGS. 2 and 301 in accordance with FIG. 3 essentially differ in the size of the pole shoe to be received or respectively the pole shoe body of the pole shoe.

FIG. 4 shows a partial section of a heat sink 401 that includes three sub-bodies 406 that are joined at the connections 402. The connections 402 have a tubular design. Within the tubular connections 402, joints 405 to the hollow sub-bodies 406 are visible. Thus, the coolant can be pumped from one connection 402 via the joint 405 into the heat sink 401 in order to flow through it and to conduct the heat. Through the other one of the two connections 402, the coolant is conveyed away again via the joint 405.

In addition, FIG. 4 partially shows a receiving space 403 for receiving a pole shoe body.

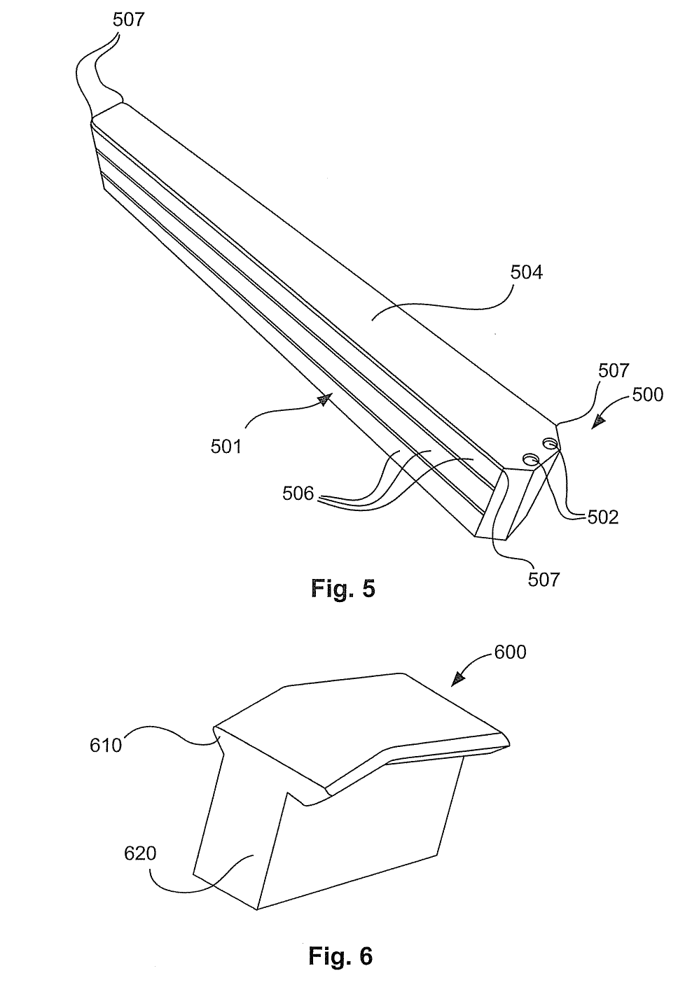

In FIG. 5, a pole shoe body 504 of a pole shoe is illustrated. Furthermore, a heat sink 501 with three sub-bodies 506 surrounding the pole shoe body 504 can be seen. The pole shoe body 504 is made of a material with a high permeability, such as iron. In addition, it has a laminated design to prevent or respectively reduce eddy currents within the pole shoe. The pole shoe body 504 is designed in the form of a cuboid, the respective corners 507 of which are flattened. In the area of the flattened corners, connections for connecting the heat sink to a cooling circuit can be arranged.

Furthermore, the figure shows two connections 502 for conveying the coolant to or respectively away from a heat exchanger.

The pole shoe may also comprise a winding 140, which is shown in FIG. 1B and which is installed on the heat sink 501. Thus, the pole shoe can be integrated into the electrical machine, for example into a rotor of a generator of a wind turbine generator system.

FIG. 6 shows an embodiment of a pole shoe 600 according to one embodiment of the invention. In the area of its pole shoe head 610 the pole shoe 600 has an arrow-shaped design. Together, the illustrated pole shoe head 610 and the pole shoe body 620 form the pole shoe 600. Preferably, the pole shoe 600 is made of individual sheet metal lamellas that are isolated from each other. Therefore, the pole shoe 600 is also referred to as laminated pole shoe core.

In one embodiment, on the pole shoe body 620 is a pole shoe sink (not shown in this figure) that surrounds the pole shoe body 620 entirely or partially. A winding, which through the close thermal contact to the heat sink is directly cooled, is installed on top of it.

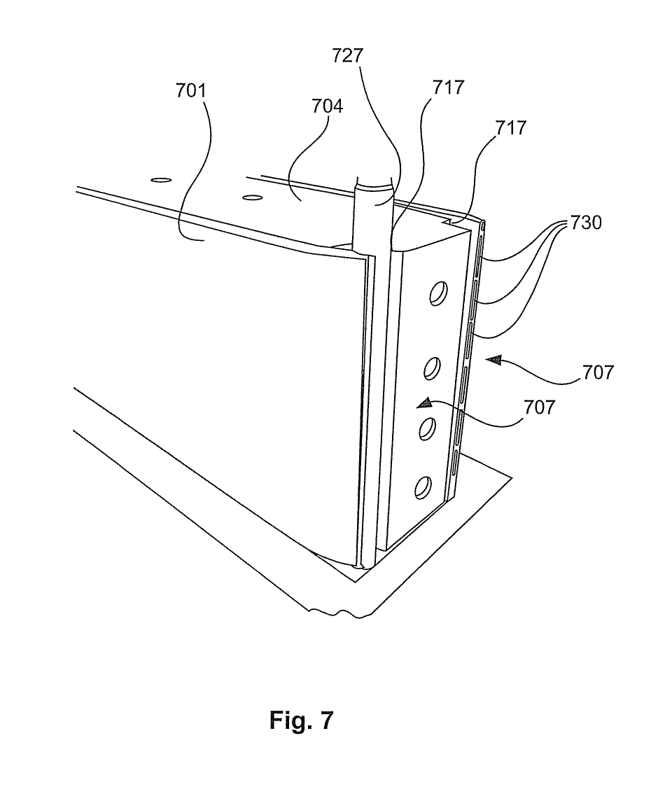

FIG. 7 shows the pole shoe body 704 of a pole shoe. Furthermore, it shows a heat sink 701, which is not divided into sub-bodies, but is designed as one body. The heat sink 701 surrounds the pole shoe body 704 essentially from three sides. The section of the pole shoe body 704 shows two corner areas 707, which respectively have a recess 717. In one of these two recesses 717, a connection 727 in the form of a connection tube for connecting a heat sink 701 is provided in order to connect the heat sink 701 to the cooling circuit. In the area of the other recess, a respective connection 727 is still missing and conveying channels 730 designed for conveying a coolant in the heat sink 701 are visible. Here, too, upon completion, such a connection 727 is to be provided which is arranged in one of the recesses 717 and is thus, at least partially, integrated into the pole shoe body 704. The heat sink, if need be, complemented by an insulation, can receive a winding and thus form a cooled spool body.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A pole shoe of an electrical generator of a wind turbine generator system, the pole shoe comprising:
a winding configured to conduct an electrical current and produce a magnetic field;
a pole shoe body for conducting the magnetic field produced by the winding; and
at least one heat sink at least partially surrounding the pole shoe body for cooling the pole shoe the heat sink being arranged between the pole shoe body and the winding.

2. The pole shoe according to claim 1, wherein the heat sink includes a winding body for receiving the winding.

3. The pole shoe according to claim 1, further comprising an insulation foil for electrically insulating the heat sink from the winding and for conducting heat from the winding to the heat sink.

4. The pole shoe according to claim 1, wherein the heat sink is hollow and configured to convey a coolant therethrough.

5. The pole shoe according to claim 1, wherein the heat sink is made of aluminum.

6. The pole shoe according to claim 4, wherein the heat sink comprises at least two connections for connecting a cooling system, wherein a first coolant is conveyed in to the heat sink through one of the two connections and conveyed out of the heat sink through the other of the two connections.

7. The pole shoe according to claim 1, wherein the pole show is prepared to be used in a salient pole machine.

8. A generator for transforming kinetic energy into electrical energy, the generator comprising:
a stator; and
a rotor, wherein at least one the stator and the rotor comprises a plurality of pole shoes, each of the pole shoes including:
a winding configured to conduct an electrical current and produce a magnetic field;
a pole shoe body for conducting the magnetic field produced by the winding; and
at least one heat sink at least partially surrounding the pole shoe body for cooling the pole shoe, the heat sink being arranged between the pole shoe body and the winding.

9. The generator according to claim 8, wherein the plurality of pole shoes are mounted to the rotor or the stator in such a way that each pole shoe comprises a winding that is arranged around the respective heat sink in such a way that the heat sink is arranged between the pole shoe body and the winding.

10. A pole shoe heat sink for cooling a pole shoe, the pole shoe heat sink comprising:
a rigid body configured to carry a winding and to be located around the pole shoe body.

11. The pole shoe heat sink according to claim 10, further comprising a receiving space for receiving the pole shoe body.

12. (canceled)

13. A method for manufacturing a pole shoe, the method comprising:
a heat sink on a pole shoe body for cooling a pole shoe so that the heat sink at least partially surrounds the pole shoe body;
arranging a winding on the heat sink, the heat sink being arranged between the winding and the pole shoe body.

14. The method according to claim 12, further comprising pumping a coolant through the heat sink.

15. The method according to claim 14, further comprising conveying the coolant to a heat exchanger through a first connection of the heat sink, wherein the coolant is cooled in the heat exchanger and provided back into the heat sink through a second connection.

16. The generator according to claim 8, wherein the rotor and the stator are ring shaped.
